(19) United States
(12) Patent Application Publication
(10) Pub. No.: US 2024/0051513 A1
(43) Pub. Date: Feb. 15, 2024

(54) VEHICLE

(71) Applicant: SUBARU CORPORATION, Tokyo (JP)

(72) Inventor: Chihiro OGURO, Tokyo (JP)

(21) Appl. No.: 18/224,447

(22) Filed: Jul. 20, 2023

(30) Foreign Application Priority Data
Aug. 12, 2022 (JP) 2022-128973

(51) Int. Cl. B60W 10/119; B60K 17/356; B60W 10/08; B60W 10/18

(52) U.S. Cl. CPC B60W 10/119; B60K 17/356; B60W 10/08; B60W 10/18; B60W 2710/083; B60W 2530/16; B60W 2710/18

(57) ABSTRACT

A vehicle includes right and left front driving wheels, right and left rear driving wheels, motors, brakes, and a controller. The controller includes one or more processors and one or more storage media. The one or more processors are configured to, based on a command when a predetermined operation is received from a driver while the vehicle is decelerating, apply a driving torque corresponding to a traveling resistance of the vehicle to at least one of the driving wheels from the motors, apply a first braking torque equal to or larger than the driving torque to the at least one of the driving wheels from the brakes, apply a second braking torque to the remaining driving wheels from the motors, and release the first braking torque applied to the at least one of the driving wheels from the brakes when a predetermined termination command is input.

### CROSS-REFERENCE TO RELATED APPLICATIONS

The present application claims priority from Japanese Patent Application No. 2022-128973 filed on Aug. 12, 2022, the entire contents of which are hereby incorporated by reference.

### BACKGROUND

The disclosure relates to a vehicle.

Vehicles may include multiple motors. For example, Japanese Unexamined Patent Application Publication (JP-A) No. 2021-142897 discloses an electric vehicle including motors that drive right and left front wheels, and motors that drive right and left rear wheels. In JP-A No. 2021-142897, when a force acting between each wheel and a road surface (tire force) is larger than a limit value (F>μFz), the motors are controlled based on target front wheel driving torques and target rear wheel driving torques, and target braking torques are applied to the wheels from hydraulic brakes. Since the braking torques of the hydraulic brakes are applied to the wheels in addition to the driving torques of the motors when F>μFz, the turning behavior of the electric vehicle is controlled.

### SUMMARY

An aspect of the disclosure provides a vehicle including right and left front driving wheels, right and left rear driving wheels, motors, brakes, and a controller. The motors are independently provided to the driving wheels in a one-on-one relationship. The brakes are independently provided to the driving wheels in a one-on-one relationship. The controller is configured to control the motors and the brakes. The controller includes one or more processors and one or more storage media. The one or more storage media are configured to store a command to be executed by the one or more processors. The one or more processors are configured to, based on the command when a predetermined operation is received from a driver while the vehicle is decelerating, apply a driving torque corresponding to a traveling resistance of the vehicle to at least one of the driving wheels from the motors, apply a first braking torque equal to or larger than the driving torque to the at least one of the driving wheels from the brakes, apply a second braking torque to the remaining driving wheels from the motors, and release the first braking torque applied to the at least one of the driving wheels from the brakes when a predetermined termination command is input.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram illustrating a vehicle according to an embodiment;

FIG. 2 is a functional block diagram of an ECU;

FIG. 3 illustrates an example of motor and brake torques applied to driving wheels;

FIG. 4 is a graph illustrating transition of the motor torques applied to the driving wheels;

FIG. 5 illustrates an example of trajectories of the vehicle;

FIG. 6 is a flowchart illustrating operation of a controller;

FIG. 7 illustrates another example of the motor and brake torques applied to the driving wheels;

FIG. 8 illustrates still another example of the motor and brake torques applied to the driving wheels; and

FIG. 9 illustrates still another example of the motor and brake torques applied to the driving wheels.

### DETAILED DESCRIPTION

In a vehicle using motors, each motor is switched between a driving torque for driving a wheel and a braking torque (regenerative torque) for braking the wheel. The motor rotates in opposite directions by the driving torque and the braking torque. When the motor is suddenly switched between the driving torque and the braking torque, a backlash may cause shock and noise. To avoid the shock and noise, the motor may gradually change the torque when the torque crosses zero. This control may be referred to as “zero-cross control”.

For example, the zero-cross control may be executed when the vehicle is switched from deceleration to acceleration. Since the torque gradually changes in the zero-cross control, the acceleration may be delayed. Therefore, there is a possibility that acceleration performance that satisfies a driver cannot be obtained.

It is desirable to provide a vehicle improved in acceleration performance.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

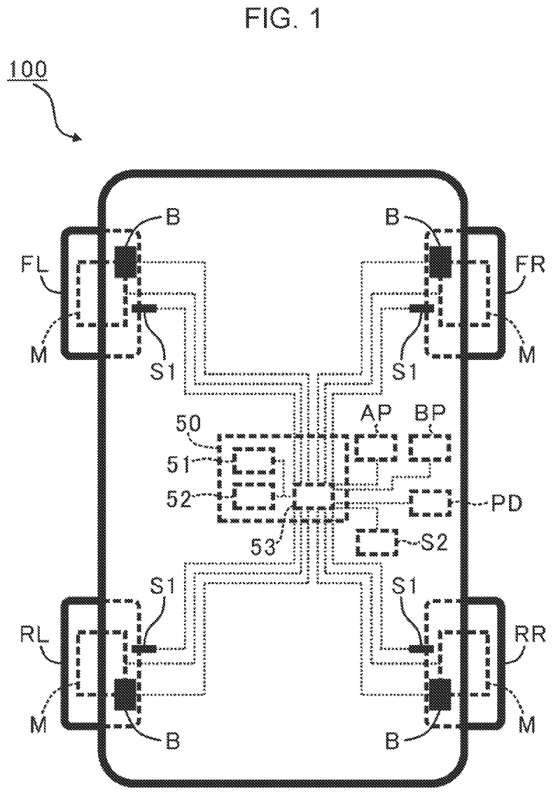

FIG. 1 is a schematic diagram illustrating a vehicle 100 according to the embodiment. The vehicle 100 includes driving wheels FR, FL, RR, and RL, motors M, brakes B, wheel speed sensors S1, an accelerator pedal AP, a brake pedal BP, a steering angle sensor S2, a paddle (inputter) PD, and an ECU 50. In one embodiment, the ECU 50 may serve as a “controller”. The vehicle 100 may further include various other components. The vehicle 100 may omit one or more of the components described above.

In this embodiment, the vehicle 100 includes four driving wheels that are the right front wheel FR, the left front wheel FL, the right rear wheel RR, and the left rear wheel RL. The number of driving wheels is not limited to four. In another embodiment, the vehicle 100 may further include one or more driven wheels that are not coupled to the motors M.

The motors M are individually provided as driving sources to the driving wheels FR, FL, RR, and RL. Examples of the motor M include an in-wheel motor. For example, the motor M may be coupled to the wheel directly or via a gear. The motor M is communicatively coupled to the ECU 50. The ECU 50 controls operation of the motor M.

Each motor M is switched between a driving torque for driving the wheel and a braking torque (regenerative torque) for braking the wheel. To accelerate the vehicle 100, the motor M applies the driving torque to the driving wheel. To decelerate the vehicle 100, the motor M applies the braking torque to the driving wheel.

The brakes B are provided to the respective driving wheels FR, FL, RR, and RL. Examples of the brake B include a hydraulic brake. An actuator (not illustrated) that controls a hydraulic pressure of the brake B is communicatively coupled to the ECU 50. The ECU 50 controls operation of the brake B. For example, the brake B applies the braking torque to the driving wheel when the target braking torque cannot be obtained by the braking torque of the motor M.

The wheel speed sensors S1 are provided to the respective driving wheels FR, FL, RR, and RL. The wheel speed sensor S1 detects a rotation speed of the wheel. The wheel speed sensor S1 is communicatively coupled to the ECU 50, and transmits detected data to the ECU 50.

The accelerator pedal AP is communicatively coupled to the ECU 50, and a depression amount of the accelerator pedal AP is transmitted to the ECU 50. The ECU 50 adjusts the opening degree of a throttle valve (not illustrated) based on the depression amount of the accelerator pedal.

The brake pedal BP is communicatively coupled to the ECU 50, and a depression amount of the brake pedal BP is transmitted to the ECU 50. The ECU 50 adjusts the braking torques of the motors M and the brakes B based on the depression amount of the brake pedal.

The steering angle sensor S2 detects a steering angle of a steering wheel (not illustrated). The steering angle sensor S2 is communicatively coupled to the ECU 50, and transmits detected data to the ECU 50.

The paddle PD is an inputter to be used for executing quick acceleration control described later. The paddle PD may be provided near a driver's seat within a range that can be reached by the driver's hand, such as a steering wheel. The inputter to be used for executing the quick acceleration control is not limited to the paddle PD, and may be any other component such as a button near the steering wheel. The paddle PD is communicatively coupled to the ECU 50. The ECU 50 executes the quick acceleration control when the paddle PD is operated.

For example, the ECU 50 includes one or more processors 51 such as a CPU, one or more storage media 52 such as a ROM and a RAM, and one or more connectors 53. The ECU 50 may further include any other component. The components of the ECU 50 are communicatively coupled to each other by a bus. The storage medium 52 stores one or more programs to be executed by the processor 51. The programs include commands for the processor 51. The operation of the ECU 50 according to the embodiment of the disclosure is implemented by the processor 51 executing the commands stored in the storage medium 52. The ECU 50 is communicatively coupled to the components of the vehicle 100 via the connector 53.

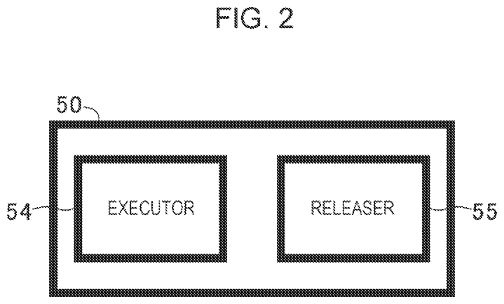

FIG. 2 is a functional block diagram of the ECU 50. The processor 51 serves as an executor 54 that executes the quick acceleration control based on a command stored in the storage medium 52 when the paddle PD is operated. In the quick acceleration control, the acceleration performance is improved when the vehicle 100 is switched from deceleration to acceleration.

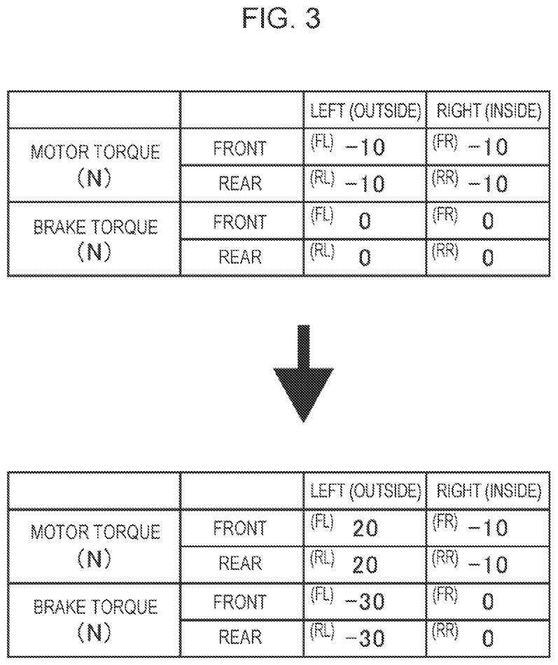

FIG. 3 illustrates an example of the torques applied to the driving wheels FR, FL, RR, and RL from the motors M and the brakes B. In this example, the quick acceleration control is executed when the vehicle 100 is switched from deceleration to acceleration while making a turn, for example, when the vehicle 100 exits a curve. In the embodiment of the disclosure, this mode may be referred to also as “first mode”. In this example, the vehicle 100 turns right. Therefore, the left driving wheels are outside wheels, and the right driving wheels are inside wheels.

In FIG. 3, the upper table shows torques applied to the driving wheels FR, FL, RR, and RL from the motors M and the brakes B before the quick acceleration control is executed. In FIG. 3, the lower table shows torques applied to the driving wheels FR, FL, RR, and RL from the motors M and the brakes B when the quick acceleration control is executed. Among the torques of the motors M in the upper and lower tables, the positive torque is a driving torque, and the negative torque is a braking torque. The torques of the brakes B in the lower table include negative torques, that is, braking torques alone.

Referring to the upper table of FIG. 3, the driving wheels FR, FL, RR, and RL receive braking torques of −10 (N) from the motors M before the quick acceleration control is executed. That is, the overall braking torque of the vehicle 100 is represented by “−10×4=−40 (N)”.

Referring to the lower table of FIG. 3, the outside driving wheels FL and RL receive driving torques from the motors M when the quick acceleration control is executed. The outside driving wheels FL and RL also receive braking torques from the brakes B. In one embodiment, these braking torques may serve as “first braking torques”.

For example, the outside driving wheels FL and RL receive driving torques of 20 (N) in FIG. 3 from the motors M as driving torques corresponding to a traveling resistance. In the example of FIG. 3, the overall traveling resistance of the vehicle 100 is 40 (N). The two outside driving wheels FL and RL receive the driving torques corresponding to the traveling resistance of 40 (N) from the motors M. Thus, each of the driving wheels FL and RL receives the driving torque of 20 (N) from the motor M.

The overall traveling resistance of the vehicle 100 generally depends on a vehicle speed. For example, the storage medium 52 of the ECU 50 may store a table showing a relationship between the vehicle speed and the traveling resistance. When the paddle PD is operated, the processor 51 may calculate the vehicle speed based on data detected by the wheel speed sensors S1 and read the traveling resistance corresponding to the calculated vehicle speed from the table. Alternatively, the processor 51 may calculate the traveling resistance of the vehicle 100 by using data acquired from various sensors based on a known mathematical expression for calculating the traveling resistance.

The outside driving wheels FL and RL receive braking torques of −30 (N) in FIG. 3 from the brakes B as braking torques (first braking torques) having absolute values equal to or larger than those of the driving torques applied from the motors M. In this example, the first braking torque from the brake B is larger than the driving torque from the motor M. The total of the torques applied to each of the outside driving wheels FL and RL is represented by “−30+20=−10 (N)”. Thus, each of the outside driving wheels FL and RL receives the braking torque of −10 (N).

The inside driving wheels FR and RR receive braking torques from the motors M to keep the overall braking torque before the quick acceleration control is executed. In one embodiment, these braking torques may serve as “second braking torques”.

For example, the inside driving wheels FR and RR receive braking torques of −10 (N) from the motors M. Thus, the overall braking torque of the vehicle 100 is represented by “20×2−10×2−30×2=−40 (N)”. In this way, the overall braking torque of the vehicle 100 is kept at −40 (N) even after the quick acceleration control is executed.

Referring to FIG. 2, the processor 51 serves as a releaser 55 that releases the braking torques of the brakes B when a predetermined termination command is input after the paddle PD is operated. The termination command may include, for example, an operation on the accelerator pedal AP.

Referring to the lower table of FIG. 3, when the brakes B release the braking torques of −30 (N) for the outside driving wheels FL and RL, the overall torques applied to the outside driving wheels FL and RL are quickly switched to the driving torques of 20 (N) from the motors M.

When the braking torques from the brakes B are released, the processor 51 applies driving torques to the driving wheels FR, FL, RR, and RL based on the depression amount of the accelerator pedal AP (not illustrated in FIG. 3).

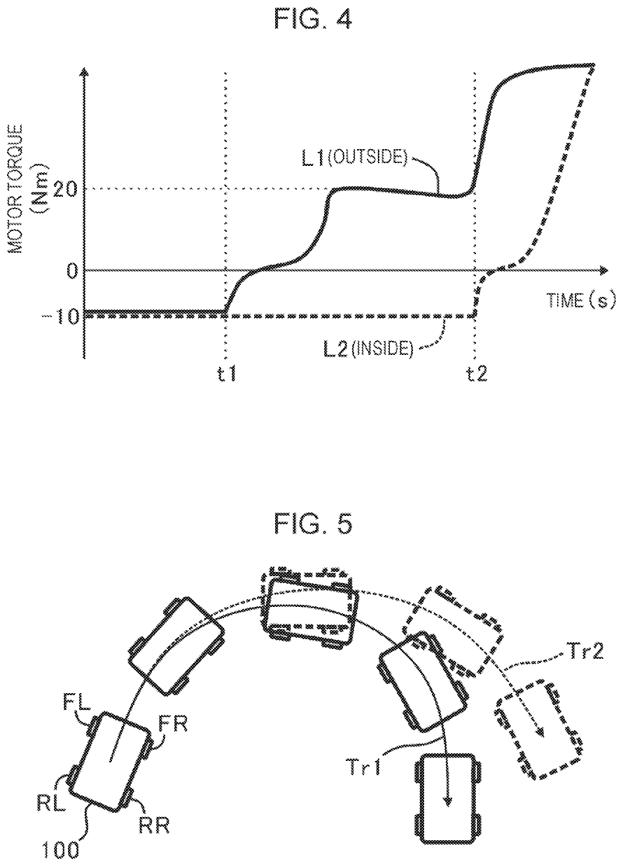

FIG. 4 is a graph illustrating transition of the torques applied to the driving wheels FR, FL, RR, and RL from the motors M. The torques in FIG. 4 correspond to the torques from the motors M in FIG. 3. The horizontal axis represents time, and the vertical axis represents the torques from the motors M. A solid line L1 indicates the torques applied to the outside driving wheels FL and RL. A broken line L2 indicates the torques applied to the inside driving wheels FR and RR.

At a time t1, the paddle PD is operated and the quick acceleration control is executed. At a time t2, the brake pedal BP is released and the accelerator pedal AP is depressed. Therefore, the termination command is input.

Before the time t1 when the quick acceleration control is executed, the vehicle 100 is decelerating while turning right, and the driving wheels FR, FL, RR, and RL receive the braking torques of −10 (N) from the motors M.

When the paddle PD is operated and the quick acceleration control is executed at the time t1, the outside driving wheels FL and RL receive the driving torques of 20 (N) from the motors M as indicated by the solid line L1. That is, the torques increase from −10 (N) to 20 (N). The torques gradually increase when crossing 0 (N) (zero-cross control).

Since the vehicle 100 is still decelerating, the overall traveling resistance of the vehicle 100 continues to decrease slightly. The outside driving wheels FL and RL indicated by the solid line L1 receive the driving torques corresponding to the traveling resistance from the motors M. Therefore, the torques applied to the outside driving wheels FL and RL continue to decrease slightly from 20 (N) as indicated by the solid line L1.

As indicated by the broken line L2, the inside driving wheels FR and RR continue to receive the braking torques of −10 (N) from the motors M even after the time t1.

When the brake pedal BP is released and the accelerator pedal AP is depressed at the time t2 and therefore the termination command is input, the brakes B release the braking torques for the outside driving wheels FL and RL (not illustrated in FIG. 4). The processor 51 applies driving torques to the driving wheels FR, FL, RR, and RL from the motors M based on the depression amount of the accelerator pedal AP. Therefore, the torques applied to the driving wheels FR, FL, RR, and RL increase as indicated by the solid line L1 and the broken line L2. As indicated by the broken line L2, the torques applied to the inside driving wheels FR and RR gradually increase when crossing 0 (N) (zero-cross control).

As indicated by the solid line L1, the outside driving wheels FL and RL simultaneously exert the driving torques of 20 (N) when the accelerator pedal AP is depressed at the time t2. Thus, the acceleration of the outside driving wheels FL and RL is improved.

When the quick acceleration control is not executed, all the driving wheels FR, FL, RR, and RL receive the torques indicated by the broken line L2 from the motors M. In this case, the torques applied to all the driving wheels FR, FL, RR, and RL gradually increase when crossing 0 (N). Thus, the overall acceleration of the vehicle 100 is delayed.

FIG. 5 illustrates an example of trajectories of the vehicle 100. FIG. 5 illustrates an example of a trajectory of the vehicle 100 when the torques are applied as illustrated in FIG. 3. A trajectory Tr1 is a trajectory of the vehicle 100 when the quick acceleration control is executed. A trajectory Tr2 is a trajectory of the vehicle 100 when the quick acceleration control is not executed.

When the quick acceleration control is executed, the acceleration of the outside driving wheels FL and RL is improved as described above. Therefore, the vehicle 100 turns right more sharply as indicated by the trajectory Tr1. Thus, the turning radius of the trajectory Tr1 is smaller than the turning radius of the trajectory Tr2 when the quick acceleration control is not executed. As a result, it is possible to reduce a period between entry into a curve and exit from the curve.

The operation of the ECU 50 is described.

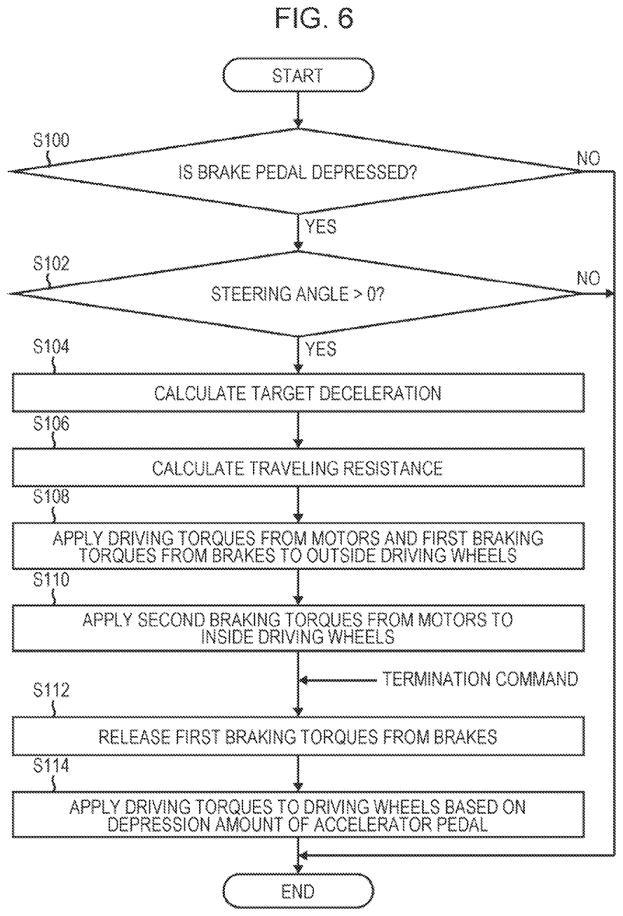

FIG. 6 is a flowchart illustrating the operation of the ECU 50. FIG. 6 illustrates the operation of the ECU 50 when the torques illustrated in FIG. 3 are applied to the vehicle 100. The operation illustrated in FIG. 6 is started when the paddle PD is operated.

The processor 51 of the ECU 50 determines whether the brake pedal BP is depressed (Step S100). As described above, the quick acceleration control is executed when the vehicle 100 is switched from deceleration to acceleration. Therefore, the processor 51 terminates the operation when the brake pedal BP is not depressed in Step S100 (NO), that is, when the vehicle 100 is not decelerating.

When the brake pedal BP is depressed in Step S100 (YES), the processor 51 determines whether the steering angle detected by the steering angle sensor S2 is larger than zero (Step S102). As described above, the quick acceleration control illustrated in FIG. 3 is executed when the vehicle 100 is switched from deceleration to acceleration while making a turn. Therefore, the processor 51 terminates the operation when the steering angle is zero in Step S102 (NO), that is, when the vehicle 100 is not making a turn.

When the steering angle is larger than zero in Step S102 (YES), the processor 51 calculates a target deceleration (Step S104). For example, the processor 51 may calculate the target deceleration based on the depression amount of the brake pedal BP.

The processor 51 calculates a traveling resistance (Step S106). As described above, the processor 51 may, for example, calculate the vehicle speed based on data detected by the wheel speed sensors S1 and read the traveling resistance corresponding to the calculated vehicle speed from the table.

The processor 51 applies, to the outside driving wheels FL and RL, the driving torques from the motors M based on the traveling resistance calculated in Step S106 and the first braking torques from the brakes B based on the traveling resistance and the target deceleration calculated in Step S104 (Step S108).

The processor 51 applies the second braking torques from the motors M to the inside driving wheels FR and RR based on the target deceleration calculated in Step S104 (Step S110).

When the brake pedal BP is released and the accelerator pedal AP is depressed and therefore the termination command is input, the processor 51 releases the first braking torques applied from the brakes B to the outside driving wheels FL and RL (Step S112).

The processor 51 applies the driving torques to the driving wheels FR, FL, RR, and RL based on the depression amount of the accelerator pedal AP (Step S114). When the torques for the driving wheels FR, FL, RR, and RL reach the driving torques based on the depression amount of the accelerator pedal AP, the processor 51 terminates the operation. When the brake pedal BP is depressed again, the processor 51 may terminate the operation.

The vehicle 100 described above includes the right and left front driving wheels FR and FL, the right and left rear driving wheels RR and RL, the motors M independently provided to the driving wheels FR, FL, RR, and RL in a one-on-one relationship, the brakes B independently provided to the driving wheels FR, FL, RR, and RL in a one-on-one relationship, and the ECU 50 that controls the motors M and the brakes B. The ECU 50 includes the one or more processors 51 and the one or more storage media 52 that store the command to be executed by the processor. The processor 51 is configured to, based on the command when an operation on the paddle PD by the driver is received while the vehicle 100 is decelerating, apply the driving torques corresponding to the traveling resistance of the vehicle 100 to at least some of the driving wheels FL and RL from the motors M, apply the first braking torques equal to or larger than the driving torques to the at least some of the driving wheels FL and RL from the brakes B, apply the second braking torques to the remaining driving wheels FR and RR from the motors M, and release the first braking torques applied to the at least some of the driving wheels FL and RL from the brakes B when a termination command is input. According to this configuration, the at least some of the driving wheels FL and RL exert the driving torques equivalent to the traveling resistance simultaneously with the input of the termination command. Thus, the acceleration performance can be improved when the vehicle 100 is switched from deceleration to acceleration.

In the vehicle 100, the processor 51 receives the operation on the paddle PD by the driver while the vehicle 100 is making a turn, and the at least some of the driving wheels include the front driving wheel FL on the outside and the rear driving wheel RL on the outside. According to this configuration, it is possible to reduce a period between a time when the vehicle 100 enters a curve and a time when the vehicle 100 exits the curve.

Another embodiment is described.

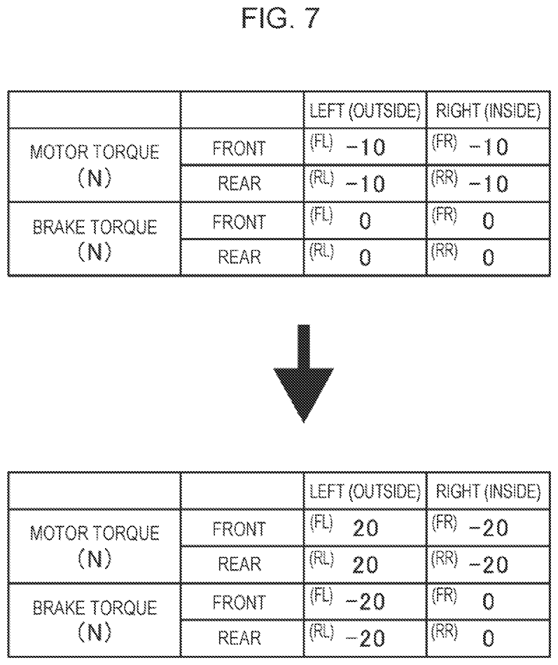

FIG. 7 illustrates another example of the torques applied to the driving wheels FR, FL, RR, and RL from the motors M and the brakes B. In this example, the quick acceleration control is executed when the vehicle 100 is switched from deceleration to acceleration while making a turn similarly to FIG. 3. Therefore, this mode is also included in the “first mode”. As shown in the lower table of FIG. 7, FIG. 7 differs from FIG. 3 in terms of values of the torques applied to the driving wheels FR, FL, RR, and RL when the quick acceleration control is executed. The other points in FIG. 7 may be the same as those in FIG. 3.

For example, the braking torques (first braking torques) applied to the outside driving wheels FL and RL from the brakes B are −20 (N) and have the same absolute values as those of the driving torques applied from the motors M. That is, the first braking torque from the brake B in this example is equal to the driving torque from the motor M. The total of the torques applied to each of the outside driving wheels FL and RL is represented by “−20+20=0 (N)”. Thus, the torques applied to each of the outside driving wheels FL and RL are canceled out.

The inside driving wheels FR and RR receive braking torques of −20 (N) from the motors M. Thus, the overall braking torque of the vehicle 100 is represented by “20×−20×2−20×2=−40 (N)”. In this way, the overall braking torque of the vehicle 100 is kept at −40 (N) even after the quick acceleration control is executed.

In this example as well, the acceleration performance of the vehicle 100 can be improved. Further, it is possible to reduce a period between entry into a curve and exit from the curve.

Still another embodiment is described.

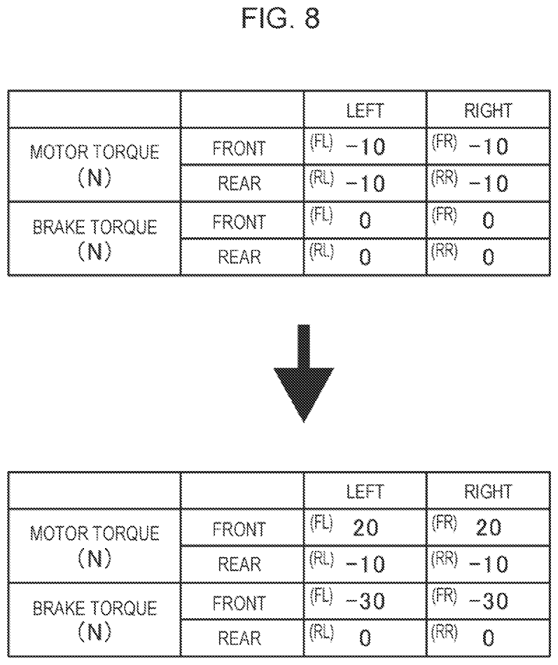

FIG. 8 illustrates still another example of the torques applied to the driving wheels FR, FL, RR, and RL from the motors M and the brakes B. FIG. 8 differs from FIG. 3 in that the acceleration of the front driving wheels FR and FL is improved when the quick acceleration control is executed. In the embodiment of the disclosure, this mode may be referred to also as “second mode”. The other points in FIG. 8 may be the same as those in FIG. 3.

Referring to the lower table of FIG. 8, when the quick acceleration control is executed, the front driving wheels FR and FL receive, for example, driving torques of 20 (N) in FIG. 8 from the motors M as the driving torques corresponding to the traveling resistance. The front driving wheels FR and FL receive braking torques of −30 (N) in FIG. 8 from the brakes B as the braking torques (first braking torques) having absolute values equal to or larger than those of the driving torques applied from the motors M.

The rear driving wheels RR and RL receive braking torques of −10 (N) from the motors M. Thus, the overall braking torque of the vehicle 100 is represented by “20×2−10×2−30×2=−40 (N)”. In this way, the overall braking torque of the vehicle 100 is kept at −40 (N) even after the quick acceleration control is executed.

Similarly to FIG. 3, the quick acceleration control illustrated in FIG. 8 can be executed in accordance with the flowchart of FIG. 6. The quick acceleration control illustrated in FIG. 8 can be executed both when the vehicle 100 is switched from deceleration to acceleration while making a turn and when the vehicle 100 is switched from deceleration to acceleration while traveling straightforward. In the case where the quick acceleration control is executed when the vehicle 100 is traveling straightforward, Step S102 need not be executed. In Step S108, the driving torques are applied from the motors M and the first braking torques are applied from the brakes B to the “front” driving wheels FR and FL. In Step S110, the second braking torques are applied from the motors M to the “rear” driving wheels RR and RL.

In this example as well, the acceleration performance of the vehicle 100 can be improved. In this example, the acceleration performance can further be improved because the acceleration of both the front driving wheels FR and FL is improved.

Still another embodiment is described.

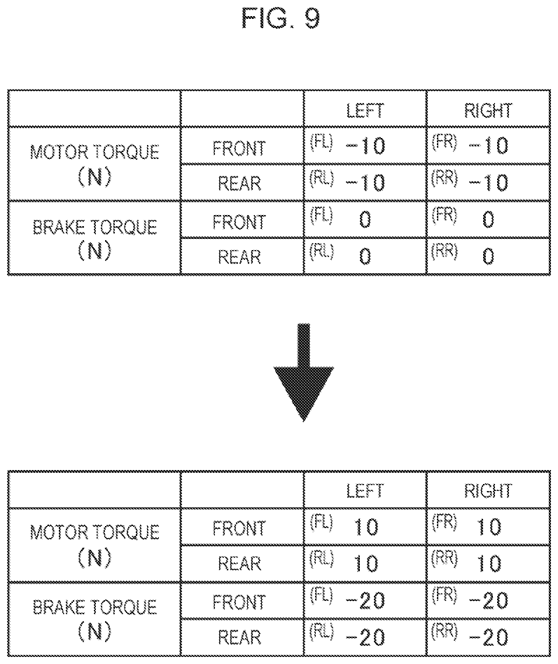

FIG. 9 illustrates still another example of the torques applied to the driving wheels FR, FL, RR, and RL from the motors M and the brakes B. FIG. 9 differs from FIG. 3 in that the acceleration of all the driving wheels FR, FL, RR, and RL is improved when the quick acceleration control is executed. In the embodiment of the disclosure, this mode may be referred to also as “third mode”. The other points in FIG. 9 may be the same as those in FIG. 3.

Referring to the lower table of FIG. 9, when the quick acceleration control is executed, all the driving wheels FR, FL, RR, and RL receive, for example, driving torques of 10 (N) in FIG. 9 from the motors M as the driving torques corresponding to the traveling resistance. All the driving wheels FR, FL, RR, and RL receive braking torques of −20 (N) in FIG. 9 from the brakes B as the braking torques (first braking torques) having absolute values equal to or larger than those of the driving torques applied from the motors M. Thus, the overall braking torque of the vehicle 100 is represented by “10×4−20×4=−40 (N)”. In this way, the overall braking torque of the vehicle 100 is kept at −40 (N) even after the quick acceleration control is executed.

Similarly to FIG. 3, the quick acceleration control illustrated in FIG. 9 can be executed in accordance with the flowchart of FIG. 6, but Step S110 need not be executed. The quick acceleration control illustrated in FIG. 9 can be executed both when the vehicle 100 is switched from deceleration to acceleration while making a turn and when the vehicle 100 is switched from deceleration to acceleration while traveling straightforward. In the case where the quick acceleration control is executed when the vehicle 100 is traveling straightforward, Step S102 need not be executed. In Step S108, the driving torques are applied from the motors M and the first braking torques are applied from the brakes B to “all” the driving wheels FR, FL, RR, and RL.

In this example as well, the acceleration performance of the vehicle 100 can be improved. In this example, the acceleration performance can further be improved because the acceleration of all the driving wheels FR, FL, RR, and RL is improved.

Although the embodiment has been described above with reference to the accompanying drawings, the embodiment of the disclosure is not limited to this embodiment. It is understood that various modifications and revisions are conceivable by persons having ordinary skill in the art within the scope of claims and are included in the technical scope disclosed herein. The steps of the ECU 50 in the embodiment need not be executed in the order described above, and may be executed in different order without causing technical contradiction.

For example, the vehicle 100 may include a switch (not illustrated) that switches the mode between two or more of the first mode, the second mode, and the third mode. For example, the processor 51 may automatically switch the first mode and either the second mode or the third mode based on the steering angle detected by the steering angle sensor S2 when the paddle PD is operated.

The ECU 50 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the ECU 50 including the executor 54 and the releaser 55. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A vehicle comprising:
driving wheels comprising right and left front driving wheels and right and left rear driving wheels;
motors respectively and independently provided to the driving wheels;
brakes respectively and independently provided to the driving wheels; and
a controller configured to control the motors and the brakes,
wherein the controller comprises one or more processors and one or more storage media configured to store a command to be executed by the one or more processors, and
wherein the one or more processors are configured to, based on the command when a predetermined operation is received from a driver who drives the vehicle while the vehicle is decelerating,
apply a driving torque corresponding to a traveling resistance of the vehicle to at least one of the driving wheels from the motors,
apply a first braking torque equal to or larger than the driving torque to the at least one of the driving wheels from the brakes,
apply a second braking torque to remaining driving wheels of the driving wheels other than the at least one of the driving wheels from the motors, and
release the first braking torque applied to the at least one of the driving wheels from the brakes when a predetermined termination command is input.

2. The vehicle according to claim 1,
wherein the one or more processors are configured to receive the predetermined operation from the driver while the vehicle is making a turn, and
wherein the at least one of the driving wheels comprise one of the right and left front driving wheels and one of the right and left front rear driving wheels that are on outside at the turn.

3. The vehicle according to claim 1, wherein the at least one of the driving wheels comprise the right and left front driving wheels.

4. The vehicle according to claim 1, wherein the at least one of the driving wheels comprise the right and left front driving wheels and the right and left rear driving wheels.
